(19) United States
(12) Patent Application Publication
(10) Pub. No.: US 2025/0180819 A1
(43) Pub. Date: Jun. 5, 2025

(54) OPTICAL CONNECTORS WITH POLARIZATION-MAINTAINING FIBERS

(71) Applicant: 3M INNOVATIVE PROPERTIES COMPANY, St. Paul, MN (US)

(72) Inventor: Michael A. Haase, St. Paul, MN (US)

(21) Appl. No.: 18/843,403

(22) PCT Filed: Mar. 1, 2023
(86) PCT No.: PCT/IB2023/051906

§ 371 Date: Sep. 3, 2024

Related U.S. Application Data
(60) Provisional application No. 63/317,705, filed on Mar. 8, 2022.

(51) Int. Cl. G02B 6/38; G02B 6/245

(52) U.S. Cl. CPC G02B 6/3803; G02B 6/245

(57) ABSTRACT

An optical ferrule assembly configured to be used in an optical connector includes an optical ferrule, an optical fiber retainer, and a plurality of polarization maintaining optical fibers. Each of the polarization maintaining optical fibers includes a core surrounded by a cladding surrounded by a buffer. The buffer is stripped at a location spaced apart from a fiber end of the polarization maintaining optical fiber to form a stripped section exposing the cladding disposed between first and second unstripped sections of the polarization maintaining optical fiber. The first unstripped section extends from the stripped section toward the fiber end of the polarization maintaining optical fiber. The fiber end is permanently attached to the optical ferrule, and the exposed cladding in the stripped section is permanently attached to the optical fiber retainer.

### SUMMARY

In some aspects of the present description, an optical ferrule assembly configured to be used in an optical connector is provided, the optical ferrule assembly including an optical ferrule, an optical fiber retainer, and a plurality of polarization maintaining optical fibers. Each of the polarization maintaining optical fibers includes a core surrounded by a cladding surrounded by a buffer. The buffer is stripped at a location spaced apart from a fiber end of the polarization maintaining optical fiber to form a stripped section exposing the cladding. The stripped section is disposed between first and second unstripped sections of the polarization maintaining optical fiber. The first unstripped section extends from the stripped section toward the fiber end of the polarization maintaining optical fiber. The fiber end of each of the plurality of polarization maintaining optical fibers is permanently attached to the optical ferrule, and the exposed cladding in the stripped section is permanently attached to the optical fiber retainer.

In some aspects of the present description, an optical ferrule assembly configured to be used in an optical connector is provided, the optical ferrule assembly including an optical ferrule, an optical fiber retainer, and a plurality of polarization maintaining optical fibers. Each of the polarization maintaining optical fibers has a core surrounded by a cladding surrounded by a buffer. Each of the polarization maintaining optical fibers is attached at a location spaced apart from a first fiber end of the polarization maintaining optical fiber to the optical fiber retainer. The optical fiber retainer applies a pressure to each of the polarization maintaining optical fibers at the location, such that the cladding of the polarization maintaining optical fiber is prevented from moving within the retainer.

In some aspects of the present description, an optical ferrule assembly configured to be used in an optical connector is provided, the optical ferrule assembly including an optical ferrule, an optical fiber retainer, and a plurality of polarization maintaining optical fibers. Each of the polarization maintaining optical fibers includes a core surrounded by a cladding surrounded by a buffer. Each of the polarization maintaining optical fibers is attached at a location spaced apart from a first fiber end of the polarization maintaining optical fiber to the optical fiber retainer. The optical fiber retainer is configured to securely hold each of the polarization maintaining optical fibers at the location such that the cladding of the polarization maintaining optical fiber is prevented from moving within the retainer. The first fiber end of each of the polarization maintaining optical fibers is permanently attached to the optical ferrule. Injecting a light with a same first polarization into each of the polarization maintaining optical fibers results in output beams from each polarization maintaining optical fiber, wherein the output beam has a same second polarization.

In some aspects of the present description, a method of making an optical ferrule assembly configured to be used in an optical connector is provided, the method including the steps of providing a plurality of polarization maintaining optical fibers, each of the polarization maintaining optical fibers having a core surrounded by a cladding surrounded by a buffer, stripping the buffer from each of the plurality of polarization maintaining optical fibers at a location spaced apart from a first fiber end of the polarization maintaining optical fiber to form a stripped section exposing the cladding and disposed between first and second unstripped sections of the polarization maintaining optical fiber, placing the plurality of polarization maintaining optical fibers within an optical fiber retainer, such that the stripped section of the plurality of polarization maintaining optical fibers is substantially within the optical fiber retainer, rotating the polarization maintaining optical fibers such that injecting a light with a same first polarization into each of the polarization maintaining optical fibers results in output beams from each polarization maintaining optical fiber, each output beam having a same second polarization, and while maintaining a rotational alignment of the polarization maintaining optical fibers, applying an adhesive to the stripped section within the optical fiber retainer, such that the cladding of the polarization maintaining optical fiber is attached to the optical fiber retainer and prevented from moving relative to the retainer.

In some aspects of the present description, an optical assembly configured to be assembled to an optical ferrule is provided, the optical assembly including an optical fiber retainer, and a plurality of polarization maintaining optical fibers. Each of the polarization maintaining optical fibers has a core surrounded by a cladding surrounded by a buffer. The buffer is stripped at a location spaced apart from a fiber end of the polarization maintaining optical fiber to form a stripped section exposing the cladding and disposed between first and second unstripped sections of the polarization maintaining optical fiber. The first unstripped section extends from the stripped section toward the fiber end of the polarization maintaining optical fiber. The exposed cladding in the stripped section is permanently attached to the optical fiber retainer.

In some aspects of the present description, an optical assembly configured to be assembled to an optical ferrule is provided, the optical assembly including an optical fiber retainer, and a plurality of polarization maintaining optical fibers. Each of the polarization maintaining optical fibers includes a core surrounded by a cladding surrounded by a buffer. Each of the polarization maintaining optical fibers is attached at a location spaced apart from a first fiber end of the polarization maintaining optical fiber to the optical fiber retainer. The optical fiber retainer is configured to securely hold each of the polarization maintaining optical fibers at the location such that the cladding of the polarization maintaining optical fiber is prevented from moving within the retainer. Injecting a light with a same first polarization into each of the polarization maintaining optical fibers results in output beams from each polarization maintaining optical fiber, wherein each output beam has a same second polarization.

### BRIEF DESCRIPTION OF THE DRAWINGS

FIGS. 1A and 1B provide views of polarization maintaining optical fibers typical in the art;

FIG. 2 is an isometric view of an optical ferrule assembly, in accordance with an embodiment of the present description;

FIGS. 3A and 3B provide end views of an optical fiber retainer before and after optical alignment of the fibers, in accordance with an embodiment of the present description;

FIG. 4 is an isometric drawing of polarization maintaining optical fibers in an optical fiber retainer, in accordance with an embodiment of the present description;

FIG. 5 is an isometric drawing of polarization maintaining optical fibers in an optical fiber retainer, in accordance with an alternate embodiment of the present description;

FIG. 6 is an illustration of how the polarization maintaining optical fibers in an optical fiber retainer may be bent to provide a “lever” for rotation of the optical fibers, in accordance with an embodiment of the present description;

FIGS. 7A and 7B provide end views of an optical fiber retainer before and after optical alignment of the fibers, showing how bent sections of the fibers may be used to rotate the fibers, in accordance with an embodiment of the present description;

FIG. 8 is an isometric view of an optical ferrule assembly including a connector housing, in accordance with an embodiment of the present description; and

FIG. 9 is a flowchart detailing the steps in a method of making an optical ferrule assembly, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Some fiber optics connectors use arrays of polarizing or polarization-maintaining (PM) optical fibers which require proper rotational alignment of each fiber within the connector. For connectors using expanded-beam ferrules, this is best accomplished by first aligning the fibers while attaching a fiber optic retainer (e.g., a collet) to the fiber array.

Photonic Integrated Circuits (PICs, e.g., Silicon Photonics PICs) are often designed to work for a specific polarization of light in the optical fibers. Maintaining that polarization between PICs, or between lasers and PICs, requires polarization-maintaining optical fibers, which may include “stress sections” (e.g., sections which have a different composition) within the fiber cladding to maintain the polarization state of the light traveling through the fibers. Optical connectors which use polarization maintaining optical fibers must control the rotational orientation of these fibers to achieve the desired coupling to the PIC.

The protective polymer buffer surrounding an optical fiber is typically only loosely attached to the glass cladding of the fiber, allowing the buffer to be easily stripped from the fiber for splicing or attaching connectors. However, this also allows the glass fiber to rotate and/or “piston” in the buffer, making it difficult to maintain rotational alignment among the optical fibers when attaching them to an optical ferrule.

According to some aspects of the present description, an optical ferrule assembly includes polarization maintaining optical fibers which include a small “stripped section” (e.g., a millimeter long) on the optical fibers some distance from the ends of the optical fibers which will be attached to the optical ferrule. This stripped section is disposed within an optical fiber retainer, or collet, and the fibers are rotated until they are in alignment optically. In some embodiments, following rotational alignment of the fibers, an adhesive is applied through the optical fiber retainer to the stripped section, securing the exposed cladding of each optical fiber in place relative to the optical fiber retainer, and “locking in” the aligned optical fibers before the open ends of the optical fibers are attached to an optical ferrule.

According to some aspects of the present description, an optical ferrule assembly configured to be used in an optical connector includes an optical ferrule, an optical fiber retainer, and a plurality of polarization maintaining optical fibers. In some embodiments, each of the polarization maintaining optical fibers may include a core (through which an optical signal propagates) surrounded by a cladding surrounded by a buffer. In some embodiments, the buffer may be stripped at a location spaced apart from a fiber end of the polarization maintaining optical fiber to form a stripped section exposing the cladding. In some embodiments, the stripped section may be disposed between first and second unstripped sections of the polarization maintaining optical fiber. In some embodiments, the first unstripped section may extend from the stripped section toward the fiber end of the polarization maintaining optical fiber (i.e., the end of the optical fiber to be connected to an optical component, such as an optical ferrule). In some embodiments, the fiber end of each of the plurality of polarization maintaining optical fibers may be permanently attached to the optical ferrule, and the exposed cladding in the stripped section may be permanently attached to the optical fiber retainer.

In some embodiments, at least some of the optical fibers in the plurality of the optical fibers may be rotated before the exposed claddings in the stripped sections of the at least some of the optical fibers are permanently attached to the optical fiber retainer. In some embodiments, a polarization axis of each of the polarization maintaining optical fibers in the plurality of the polarization maintaining optical fibers may be aligned within 10 degrees, or within 8 degrees, or within 6 degrees, or within 4 degrees, or within 2 degrees, or within 1 degree of each other. In some embodiments, a polarization axis of at least one of the polarization maintaining optical fibers may be oriented at, or within about 10 degrees of, a predefined angle with respect to the fiber retainer. In some embodiments, a polarization axis of each of the polarization maintaining optical fibers may be oriented at, or within 10 degrees of, a predefined angle with respect to the fiber retainer.

In some embodiments, the optical ferrule of the optical ferrule assembly may be configured to be connected to and aligned with another optical component, such as a photonics integrated circuit (PIC), directly (i.e., not part of an optical connector and not disposed in or connected to a housing). In other embodiments, the ferrule may be configured to be mounted in a cradle (i.e., socket) that is attached to a PIC. In some embodiments, the optical ferrule assembly may further include a housing (e.g., the housing of an optical connector), wherein the optical fiber retainer is configured to be mounted in or assembled to the housing. In some embodiments, when the optical ferrule assembly is assembled to the housing, the optical fiber retainer is mounted in the housing and provides the only attachment of the optical ferrule assembly to the housing.

According to some aspects of the present description, an optical ferrule assembly configured to be used in an optical connector includes an optical ferrule, an optical fiber retainer, and a plurality of polarization maintaining optical fibers. In some embodiments, each of the polarization maintaining optical fibers may have a core surrounded by a cladding surrounded by a buffer. In some embodiments, each of the polarization maintaining optical fibers may be attached at a location spaced apart from a first fiber end of the polarization maintaining optical fiber to the optical fiber retainer. In some embodiments, the optical fiber retainer may apply a pressure to each of the polarization maintaining optical fibers (e.g., trapping and compressing the optical fibers mechanically) at the location, such that the cladding of the polarization maintaining optical fiber is prevented from moving within the retainer.

In some embodiments, at least some of the optical fibers in the plurality of the optical fibers may be rotated before the pressure is applied to the at least some of the optical fibers. In some embodiments, for example, each of the polarization maintaining optical fibers in the plurality of the polarization maintaining optical fibers may be rotated such that they have substantially the same output polarization. In some embodiments, injecting a light with a same first polarization into each of the polarization maintaining optical fibers after the optical fibers have been rotated and aligned results in output beams from each polarization maintaining optical fiber, each output beam having a same second polarization. In some embodiments, a polarization axis of at least one of the polarization maintaining optical fibers may be oriented at, or within 10 degrees of, a predefined angle with respect to the fiber retainer. In some embodiments, a polarization axis of each of the polarization maintaining optical fibers may be oriented at, or within 10° of, a predefined angle with respect to the fiber retainer.

In some embodiments, the optical ferrule assembly may further include a housing (e.g., the housing of an optical connector), wherein the optical fiber retainer is configured to be mounted in or assembled to the housing. In some embodiments, when the optical ferrule assembly is assembled to the housing, the optical fiber retainer is mounted in the housing and provides the only attachment of the optical ferrule assembly to the housing.

According to some aspects of the present description, an optical ferrule assembly configured to be used in an optical connector may include an optical ferrule, an optical fiber retainer, and a plurality of polarization maintaining optical fibers. In some embodiments, each of the polarization maintaining optical fibers may include a core surrounded by a cladding surrounded by a buffer. In some embodiments, each of the polarization maintaining optical fibers may be attached at a location spaced apart from a first fiber end of the polarization maintaining optical fiber to the optical fiber retainer. In some embodiments, the optical fiber retainer may be configured to securely hold each of the polarization maintaining optical fibers at the location such that the cladding of the polarization maintaining optical fiber is prevented from moving within the retainer (e.g., applying a mechanical pressure to the buffer of each fiber such that it squeezes the cladding inside and prevents it from moving). In some embodiments, the first fiber end of each of the polarization maintaining optical fibers may be permanently attached to the optical ferrule. In some embodiments, injecting a light with a same first polarization into each of the polarization maintaining optical fibers results in output beams from each polarization maintaining optical fiber, wherein each output beam has a same second polarization (e.g., each of the polarization maintaining optical fibers is in rotational alignment).

In some embodiments, at least some of the optical fibers in the plurality of the optical fibers may have been rotated before the pressure is applied to the at least some of the optical fibers. In some embodiments, for example, each of the polarization maintaining optical fibers in the plurality of the polarization maintaining optical fibers may be rotated such that they have substantially the same output polarization. In some embodiments, injecting a light with a same first polarization into each of the polarization maintaining optical fibers may result in output beams from each polarization maintaining optical fiber, such that each output beam has a same second polarization.

In some embodiments, a polarization axis of at least one of the polarization maintaining optical fibers may be oriented at, or within about 10 degrees of, a predefined angle with respect to the fiber retainer. In some embodiments, a polarization axis of each of the polarization maintaining optical fibers is oriented at, or within about 10 degrees of, a predefined angle with respect to the fiber retainer.

In some embodiments, the optical ferrule assembly may further include a housing (e.g., the housing of an optical connector), wherein the optical fiber retainer is configured to be mounted in or assembled to the housing. In some embodiments, when the optical ferrule assembly is assembled to the housing, the optical fiber retainer is mounted in the housing and provides the only attachment of the optical ferrule assembly to the housing.

According to some aspects of the present description, a method of making an optical ferrule assembly configured to be used in an optical connector may include the following steps:
(a) providing a plurality of polarization maintaining optical fibers, each of the polarization maintaining optical fibers having a core surrounded by a cladding surrounded by a buffer;
(b) stripping the buffer from each of the plurality of polarization maintaining optical fibers at a location spaced apart from a first fiber end of the polarization maintaining optical fiber to form a stripped section exposing the cladding and disposed between first and second unstripped sections of the polarization maintaining optical fiber;
(c) placing the plurality of polarization maintaining optical fibers within an optical fiber retainer, such that the stripped section of the plurality of polarization maintaining optical fibers is substantially within the optical fiber retainer;
(d) rotating the polarization maintaining optical fibers such that injecting a light with a same first polarization into each of the polarization maintaining optical fibers results in output beams from each polarization maintaining optical fiber, each output beam having a same second polarization, and
(e) while maintaining a rotational alignment of the polarization maintaining optical fibers, applying an adhesive to the stripped section within the optical fiber retainer, such that the cladding of the polarization maintaining optical fiber is attached to the optical fiber retainer and prevented from moving relative to the retainer.

In some embodiments, after the rotating step, a polarization axis of at least one of the polarization maintaining optical fibers may be oriented at, or within about 10 degrees of, a predefined angle with respect to the fiber retainer. In some embodiments, after the rotating step, a polarization axis of each of the polarization maintaining optical fibers may oriented at, or within about 10 degrees of, a predefined angle with respect to the fiber retainer. In some embodiment, the step of rotating the polarization maintaining fibers may include observing the ends of the polarization maintaining fibers (i.e., to assess a position of the stress features visible within the cladding at the fiber end to see if the fibers are in rotational alignment).

In some embodiments, the method of making an optical ferrule assembly may include attaching the optical ferrule to the first ends of the polarization maintaining fibers after the fibers are rotated and attached to the optical fiber retainer.

According to some aspects of the present description, an optical assembly configured to be assembled to an optical ferrule may include an optical fiber retainer, and a plurality of polarization maintaining optical fibers. In some embodiments, each of the polarization maintaining optical fibers may have a core surrounded by a cladding surrounded by a buffer. In some embodiments, the buffer may be stripped at a location spaced apart from a fiber end of the polarization maintaining optical fiber to form a stripped section (e.g., a 1 millimeter stripped section) exposing the cladding. In some embodiments, the stripped section may be disposed between first and second unstripped sections of the polarization maintaining optical fiber. In some embodiments, the first unstripped section may extend from the stripped section toward the fiber end of the polarization maintaining optical fiber. In some embodiments, the exposed cladding in the stripped section may be permanently attached to the optical fiber retainer.

In some embodiments, at least some of the polarization maintaining optical fibers in the plurality of polarization maintaining optical fibers may be rotated before the exposed claddings in the stripped sections of the at least some of the optical fibers are permanently attached to the optical fiber retainer. In some embodiments, a polarization axis of each of the polarization maintaining optical fibers in the plurality of the polarization maintaining optical fibers may be aligned within 10 degrees, or 8 degrees, or 6 degrees, or 4 degrees, or 2 degrees, or 1 degree of each other. In some embodiments, a polarization axis of at least one of the polarization maintaining optical fibers may be oriented at, or within about 10 degrees of, a predefined angle with respect to the fiber retainer. In some embodiments, a polarization axis of each of the polarization maintaining optical fibers may be oriented at, or within about 10 degrees of, a predefined angle with respect to the fiber retainer.

According to some aspects of the present description, an optical assembly configured to be assembled to an optical ferrule may include an optical fiber retainer, and a plurality of polarization maintaining optical fibers. In some embodiments, each of the polarization maintaining optical fibers may include a core surrounded by a cladding surrounded by a buffer. In some embodiments, each of the polarization maintaining optical fibers may be attached at a location spaced apart from a first fiber end of the polarization maintaining optical fiber to the optical fiber retainer. In some embodiments, the optical fiber retainer may be configured to securely hold each of the polarization maintaining optical fibers (e.g., apply a “squeezing” mechanical pressure) at the location such that the cladding of the polarization maintaining optical fiber is prevented from moving within the retainer. In some embodiments, injecting a light with a same first polarization into each of the polarization maintaining optical fibers results in output beams from each polarization maintaining optical fiber, wherein each output beam has a same second polarization.

In some embodiments, at least some of the polarization maintaining optical fibers in the plurality of polarization maintaining optical fibers may be rotated before each of the polarization maintaining optical fibers is securely held by the optical fiber retainer. In some embodiments, a polarization axis of each of the polarization maintaining optical fibers in the plurality of the polarization maintaining optical fibers may be aligned within 10 degrees, or 8 degrees, or 6 degrees, or 4 degrees, or 2 degrees, or 1 degree of each other. In some embodiments, a polarization axis of at least one of the polarization maintaining optical fibers may be oriented at, or within about 10 degrees of, a predefined angle with respect to the fiber retainer. In some embodiments, a polarization axis of each of the polarization maintaining optical fibers may be oriented at, or within about 10 degrees of, a predefined angle with respect to the fiber retainer.

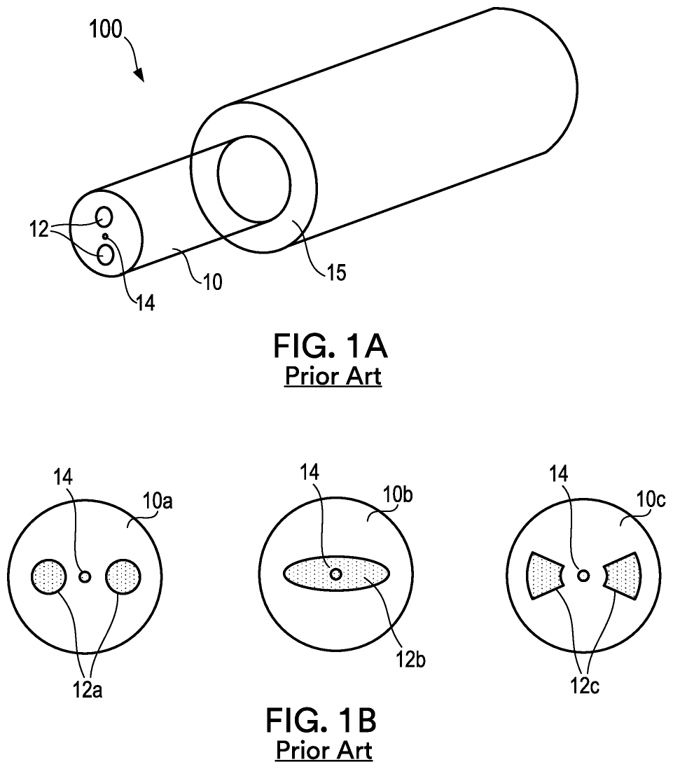

Turning now to the figures, FIGS. 1A and 1B provide views of polarization maintaining optical fibers typical in the art. FIG. 1A shows a section of a polarization maintaining (PM) optical fiber 100. PM optical fiber 100 includes a fiber core 14 surrounded by a cladding 10, which in turn is surrounded by a buffer 15. In some embodiments, cladding 10 of optical fiber 100 may include stress sections 12, which are sections of the cladding with a different composition around or near the core 14 to help maintain the polarization state of the light traveling through fiber 100. These stress sections 12 work by intentionally introducing a birefringence in the optical fiber, creating two well-defined polarizations modes which propagate along the fiber.

There are several different designs which can be used to create the necessary birefringence in an optical fiber. FIG. 1B illustrates three examples of such optical fibers. The examples of FIG. 1B are for illustration only and are not intended to be limiting. In the example on the far left of FIG. 1B, stress sections 12a in cladding 10a have a circular cross-section and appear on opposite sides of core 14. This style of stress section design is often referred to as PANDA in the industry (the name refers to the resemblance of the cross-section to the face of a panda and is also an acronym for “Polarization-maintaining AND Absorption-reducing”). Other example designs typical in the art include the elliptical-clad design in the middle of FIG. 1B, with elliptically shaped stress section 12b in cladding 10b, and the “bow-tie” design shown in the far right of FIG. 1B, with stress sections 12c resembling the two halves of a bow tie in cladding 10c.

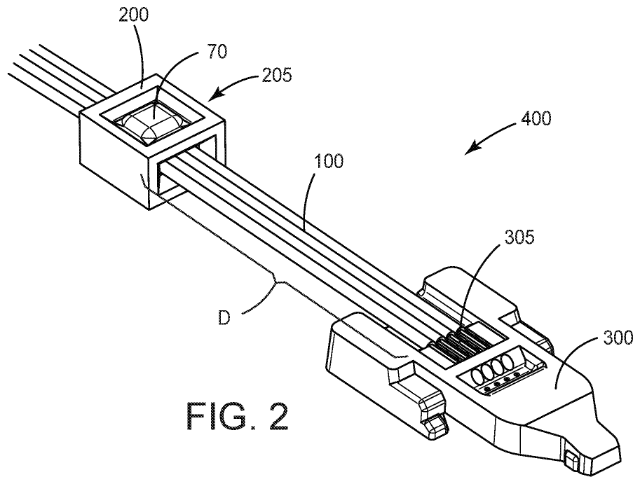

FIG. 2 is an isometric view of an optical ferrule assembly, according to one embodiment of the present description. In optical ferrule assembly 400, a plurality of PM optical fibers 100 pass through and are held in place by optical fiber retainer 200 (e.g., an optical fiber collet). In some embodiments, optical fiber retainer 200 may have an opening 205 through which a section of PM optical fibers 100 may be accessed while in optical fiber retainer 200. For example, as explained elsewhere herein, a stripped section of PM optical fibers 100 (i.e., a section where the buffer is stripped away, exposing the cladding inside) may be contained substantially within optical fiber retainer 200, such that an adhesive 70 may be applied through opening 205 to the stripped section of PM optical fibers 100, to prevent the claddings from moving back and forth or rotating within their buffers.

In some embodiments, optical ferrule assembly 400 may include an optical ferrule 300, attached to PM optical fibers 100 at an attaching location 305 at an end of PM optical fibers 100. In some embodiments, optical ferrule 300 is attached to PM optical fibers 100 at a predetermined distance D from the point where optical fiber retainer 200 retains PM optical fibers 100. In some embodiments, this distance D may be relative short (e.g., within 5 mm, or within 10 mm, or within 20 mm) such that a rotation of PM optical fibers 100 held firm by optical fiber retainer 200 is substantially remained at attaching location 305 (i.e., there is insufficient distance for PM optical fibers 100 to rotate significantly relative to their rotation at optical fiber retainer 200).

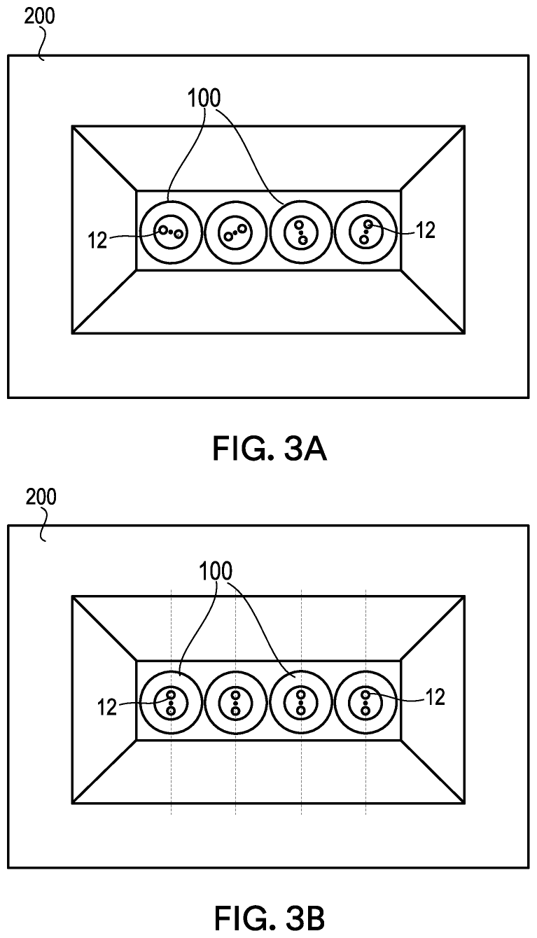

FIGS. 3A and 3B provide end views of one embodiment of optical fiber retainer 200 before and after optical alignment of the fibers, respectively. FIG. 3A shows an end view of optical fiber retainer 200 such that cross-sectional shapes of PM optical fibers 100 are visible as they exit optical fiber retainer 200 (facing optical ferrule 300, see FIG. 2). In the view of FIG. 3A, one can view the relative orientations of stress sections 12 visible at the exposed ends of PM optical fibers 100. Typically, the rotation of the PM optical fibers 100 is not initially controlled (i.e., one or more of the rotations of PM optical fibers 100 are not aligned with the rotations of one or more other PM optical fibers 100, as shown in FIG. 3A. The rotation of each PM optical fiber 100 is random).

Before the orientation of the PM optical fibers 100 is “locked down” (e.g., by an adhesive applied through optical fiber retainer 200, or by the optical fiber retainer 200 applying a mechanical pressure to PM optical fibers 100 to keep them from rotating), the rotation of PM optical fibers 100 must be aligned. FIG. 3B shows an embodiment where the stress sections 12 of each PM optical fiber 100 are substantially in alignment (e.g., aligned along a same direction or rotational orientation, or within 10 degrees of the same orientation).

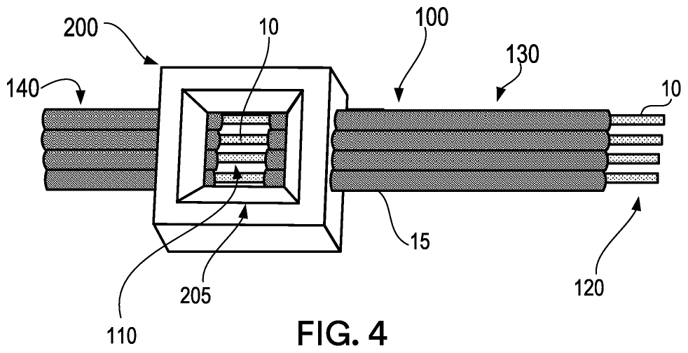

FIG. 4 is an isometric drawing of one embodiment of polarization maintaining optical fibers 100 in an optical fiber retainer 200. In this embodiment, the buffer 15 is removed from a portion of PM optical fibers 100, creating stripped section 110 where the cladding 10 of PM optical fibers 100 is exposed. In some embodiments, stripped section 110 is disposed between a first unstripped section 130 and second unstripped section 140 of PM optical fibers 100 and substantially contained within optical fiber retainer 200 and may be exposed through opening 205 in optical fiber retainer 200. In some embodiments, the fiber ends 120 of PM optical fibers 100 may be examined (i.e., the stress sections visible at the cross-sectional ends of cladding 10 at fiber ends 120, see also FIG. 3A) to determine if the stress sections are in rotational alignment. As described elsewhere herein, PM optical fibers 100 may be rotated until the stress sections visible at fiber ends 120 are in alignment, and then an adhesive (not shown in FIG. 4) may be applied to the stripped section 110 through opening 205 in optical fiber retainer 200 to lock in the rotational alignment, before fiber ends 120 are connected permanently to an optical component (e.g., the optical ferrule 300 of FIG. 2).

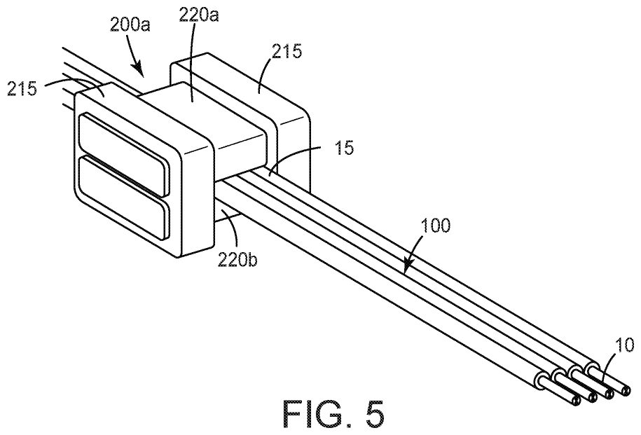

FIG. 5 shows an alternate embodiment of an optical fiber retainer 200a, according to the present description. In this embodiment, PM optical fibers 100 do not have a stripped section (such as stripped section 110 shown in FIG. 4). Instead, optical fiber retainer 200a is configured to apply a mechanical pressure to unstripped sections of PM optical fibers 100, such that the buffers 15 of PM optical fibers 100 applies pressure to the claddings 10 contained within and prevents them from rotating or “pistoning” (i.e., sliding back and forth longitudinally) within the buffers 15. In some embodiments, for example optical fiber retainer 200a may include a top section 220a and a bottom section 220b which may be pressed together, applying pressure between them on PM optical fibers 100. In some embodiments, clamping pieces 215 may be applied to optical fiber retainer 200a to maintain the pressure of top section 220a and bottom section 220b on PM optical fibers 100.

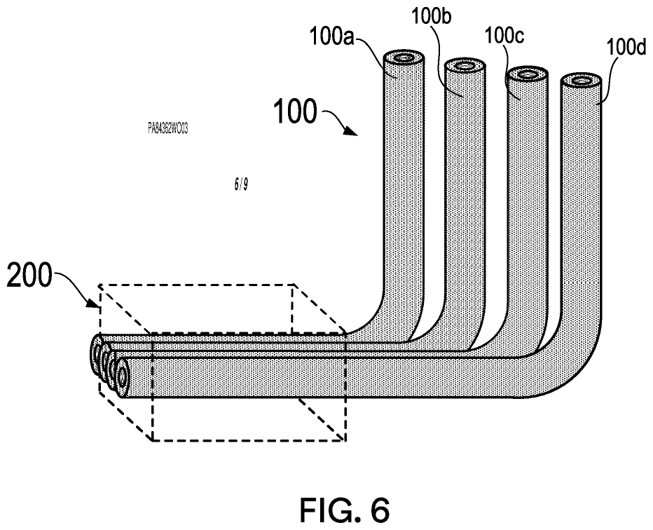

One method of rotating each of the PM optical fibers 100 is shown in FIG. 6. FIG. 6 is intended for illustration purposes only and is not meant to be limiting. Other methods of rotating the optical fibers may be used as appropriate. As shown in FIG. 6, a section of each of PM optical fibers 100 (including individual fibers 100a, 100b, 100c, and 100d in this example) may be bent upward to create a physical lever that may be used to rotate the individual fibers within optical fiber retainer 200 (shown here as a dashed box to show placement of PM optical fibers 100 within).

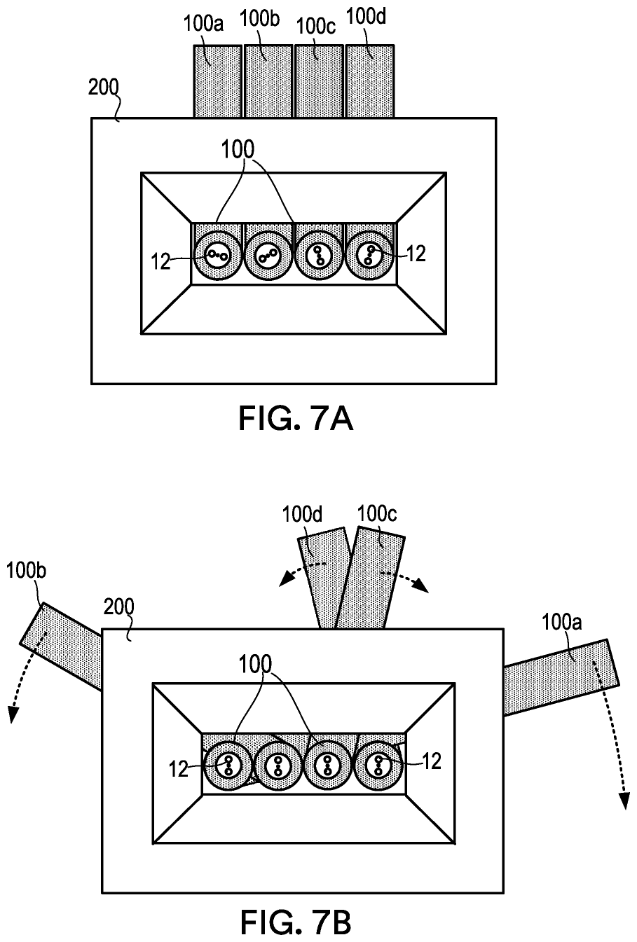

These “lever arms” of PM optical fibers 100 may be used as demonstrated in FIGS. 7A and 7B. FIGS. 7A and 7B provide end views of optical fiber retainer 200 before and after optical alignment of PM optical fibers 100, including a front view of bent section of fibers to be used as lever arms. FIG. 7A shows the initial placement of PM optical fibers 100 within optical fiber retainer 200. In this initial configuration, the orientations of stress sections 12 for each PM optical fiber 100 are random, and the bent lever arms of PM optical fibers 100 extending up behind optical fiber retainer 200 are substantially parallel. FIG. 7B shows the embodiment after the fiber lever arms are rotated either clockwise or counter-clockwise individually until the stress sections 12 of PM optical fibers 100 are substantially aligned. In the example of FIG. 7B, the lever arm of fiber 100a was rotated significantly clockwise, the lever arm of 100b was rotated significantly counter-clockwise, the lever arm of 100c was rotated slightly clockwise, and the lever arm of 100d was rotated slightly counter-clockwise, with the end result being the stress sections 12 of each PM optical fiber 100 being substantially in alignment. In some embodiments, a twisting tool (not shown) may be used to grasp each individual lever arm (e.g., at different distances behind optical fiber retainer 200 in order to allow freedom of rotation for the individual lever arms) and aid in the rotation of PM optical fibers 100. After the fibers are permanently attached within the retainer, the twisting tool may be removed and the lever arms released.

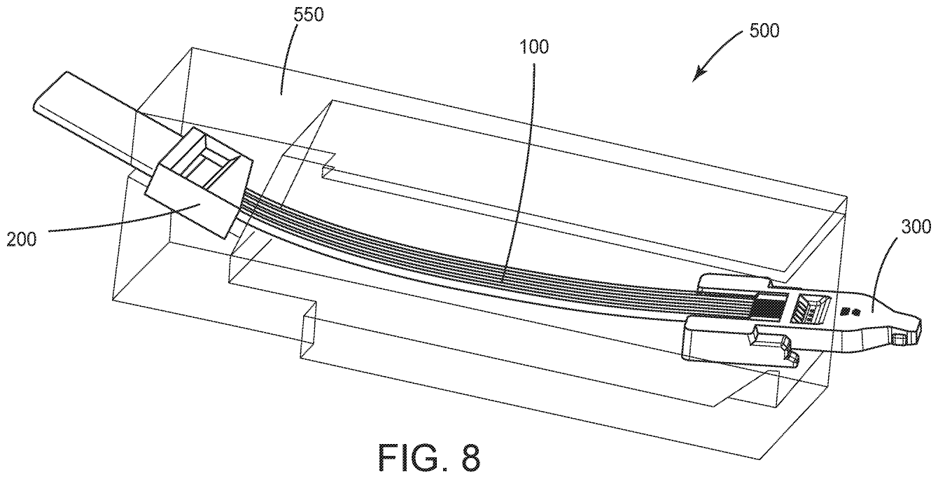

FIG. 8 is an isometric view of one embodiment of an optical ferrule assembly including a connector housing. In some embodiments, optical ferrule assembly 500 includes a connector housing 550, optical fiber retainer 200, optical ferrule 300, and a plurality of PM optical fibers 100. In some embodiments, PM optical fibers 100 are retained within (and permanently attached to) optical fiber retainer 200 and are attached to optical ferrule 300 at an end of PM optical fibers 100. In some embodiments, optical fiber retainer 200 is mounted in and attached to connector housing 550. In some embodiments, optical fiber retainer 200 is the only point of attachment for PM optical fibers 100 (i.e., in some embodiments, optical ferrule 300 may be allowed to float within connector housing 550). In other embodiments, such as the embodiment shown in FIG. 2, the optical ferrule assembly may be attached to an optical component (e.g., a PIC) without connector housing 550.

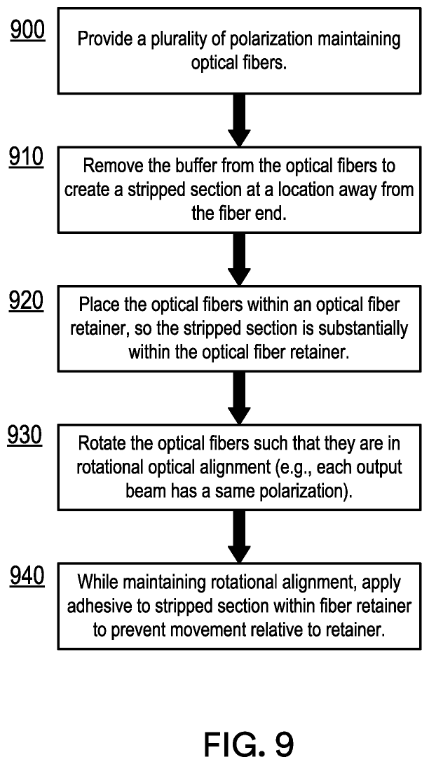

Finally, FIG. 9 is a flowchart detailing the steps in one embodiment of a method of making an optical ferrule assembly. The steps in this embodiment include:

Step 900. Providing a plurality of polarization maintaining optical fibers, each of the polarization maintaining optical fibers having a core surrounded by a cladding surrounded by a buffer.

Step 910. Stripping the buffer from each of the polarization maintaining optical fibers at a location spaced apart from a first fiber end of the polarization maintaining optical fiber to form a stripped section exposing the cladding and disposed between first and second unstripped sections of the polarization maintaining optical fiber (see also FIG. 4).

Step 920. Placing the plurality of polarization maintaining optical fibers within an optical fiber retainer, such that the stripped section of the plurality of polarization maintaining optical fibers is substantially within the optical fiber retainer.

Step 930. Rotating the polarization maintaining optical fibers (see, e.g., FIGS. 7A-7B) such that injecting a light with a same first polarization into each of the polarization maintaining optical fibers results in output beams with a substantially similar second polarization (i.e., such that the PM optical fibers are substantially in rotational alignment, or within about 10 degrees or less of alignment).

Step 940. While maintaining rotational alignment of the PM optical fibers, applying an adhesive to the stripped section within the optical fiber retainer, such that the cladding of the polarization maintaining optical fiber is attached to the optical fiber retainer and prevented from moving (e.g., rotating or pistoning) relative to the retainer.

It should be noted that other embodiments of this method are possible within the bounds and intent of the present description. For example, for the optical fiber retainer 200a shown in FIG. 5, the steps of stripping the PM optical fibers and applying an adhesive to the fibers is not needed, as the fibers are kept from rotating by the mechanical pressure applied by optical fiber retainer 200a.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed:

1. An optical ferrule assembly configured to be used in an optical connector and comprising:
an optical ferrule;
an optical fiber retainer; and
a plurality of polarization maintaining optical fibers, each of the polarization maintaining optical fibers comprising a core surrounded by a cladding surrounded by a buffer, the buffer stripped at a location spaced apart from a fiber end of the polarization maintaining optical fiber to form a stripped section exposing the cladding and disposed between first and second unstripped sections of the polarization maintaining optical fiber, the first unstripped section extending from the stripped section toward the fiber end of the polarization maintaining optical fiber, the fiber end permanently attached to the optical ferrule, the exposed cladding in the stripped section permanently attached to the optical fiber retainer.

2. The optical ferrule assembly of claim 1, wherein at least some of the optical fibers in the plurality of the optical fibers are rotated before the exposed claddings in the stripped sections of the at least some of the optical fibers are permanently attached to the optical fiber retainer.

3. The optical ferrule assembly of claim 1, wherein a polarization axis of each of the polarization maintaining optical fibers in the plurality of the polarization maintaining optical fibers are aligned within 10 (or 8, or 6, or 4, or 2, or 1) degrees of each other.

4. The optical ferrule assembly of claim 1, wherein a polarization axis of at least one of the polarization maintaining optical fibers is oriented at (or within 10° of) a predefined angle with respect to the fiber retainer.

5. The optical ferrule assembly of claim 1, wherein a polarization axis of each of the polarization maintaining optical fibers is oriented at (or within 10° of) a predefined angle with respect to the fiber retainer.

6. The optical ferrule assembly of claim 1, further comprising a housing, wherein the optical fiber retainer is configured to be mounted in the housing.

7. The optical ferrule assembly of claim 6, wherein when the optical ferrule assembly is assembled to the housing, the optical fiber retainer is mounted in the housing and provides the only attachment of the optical ferrule assembly to the housing.

8. An optical ferrule assembly configured to be used in an optical connector and comprising:
an optical ferrule;
an optical fiber retainer; and
a plurality of polarization maintaining optical fibers, each of the polarization maintaining optical fibers comprising a core surrounded by a cladding surrounded by a buffer and attached at a location spaced apart from a first fiber end of the polarization maintaining optical fiber to the optical fiber retainer, the optical fiber retainer applying a pressure to each of the polarization maintaining optical fibers at the location, such that the cladding of the polarization maintaining optical fiber is prevented from moving within the retainer.

9. The optical ferrule assembly of claim 8, wherein at least some of the optical fibers in the plurality of the optical fibers are rotated before the pressure is applied to the at least some of the optical fibers.

10. The optical ferrule assembly of claim 8, wherein each of the polarization maintaining optical fibers in the plurality of the polarization maintaining optical fibers are rotated such that they have substantially the same output polarization.

11. The optical ferrule assembly of claim 8, wherein injecting a light with a same first polarization into each of the polarization maintaining optical fibers results in output beams from each polarization maintaining optical fiber, each output beam having a same second polarization.

12. The optical ferrule assembly of claim 8, wherein a polarization axis of at least one of the polarization maintaining optical fibers is oriented at (or within 10° of) a predefined angle with respect to the fiber retainer.

13. The optical ferrule assembly of claim 8, wherein a polarization axis of each of the polarization maintaining optical fibers is oriented at (or within 10° of) a predefined angle with respect to the fiber retainer.

14. The optical ferrule assembly of claim 8, further comprising a housing, wherein the optical fiber retainer is configured to be mounted in the housing.

15. The optical ferrule assembly of claim 14, wherein when the optical ferrule assembly is assembled to the housing, the optical fiber retainer is attached to the housing and provides the only attachment of the optical ferrule assembly to the housing.

16. An optical ferrule assembly configured to be used in an optical connector and comprising:
an optical ferrule;
an optical fiber retainer; and
a plurality of polarization maintaining optical fibers, each of the polarization maintaining optical fibers comprising a core surrounded by a cladding surrounded by a buffer and attached at a location spaced apart from a first fiber end of the polarization maintaining optical fiber to the optical fiber retainer, the optical fiber retainer configured to securely hold each of the polarization maintaining optical fibers at the location such that the cladding of the polarization maintaining optical fiber is prevented from moving within the retainer, the first fiber end permanently attached to the optical ferrule;
wherein injecting a light with a same first polarization into each of the polarization maintaining optical fibers results in output beams from each polarization maintaining optical fiber, each output beam having a same second polarization.

17. The optical ferrule assembly of claim 16, wherein a polarization axis of at least one of the polarization maintaining optical fibers is oriented at (or within 10° of) a predefined angle with respect to the fiber retainer.

18. The optical ferrule assembly of claim 16, wherein a polarization axis of each of the polarization maintaining optical fibers is oriented at (or within 10° of) a predefined angle with respect to the fiber retainer.

19. The optical ferrule assembly of claim 16, further comprising a housing, wherein the optical fiber retainer is configured to be mounted in the housing.
